(19) United States
(12) Patent Application Publication
(10) Pub. No.: US 2019/0375594 A1
(43) Pub. Date: Dec. 12, 2019

(54) Systems And Methods For Object Storage And Retrieval

(71) Applicant: Walmart Apollo, LLC, Bentonville, AR (US)

(72) Inventors: David G. Tovey, Rogers, AR (US); Paul Edward Durkee, Centerton, AR (US); Kurt William Robert Bessel, Mexico, NY (US)

(21) Appl. No.: 16/433,597

(22) Filed: Jun. 6, 2019

Related U.S. Application Data
(60) Provisional application No. 62/681,970, filed on Jun. 7, 2018.

(51) Int. Cl. B65G 1/137; B65G 1/04

(52) U.S. Cl. CPC B65G 1/1375; B65G 1/045

(57) ABSTRACT

Described in detail herein is object storage and retrieval system. Each of multiple storage towers can store and dispense physical objects. The storage towers can be an octagonal prism-shaped housing, a shelving unit disposed within the housing, and one or more receptacles defining one or more openings in the housing. A loader disposed in the housing of each storage tower, can transfer one or more of the physical objects between the one or more receptacles and shelves of the shelving unit. An intermediate transport apparatus disposed external to the storage towers and positioned between two or more of the storage towers, can be aligned with one of the one or more receptacles of each of the two or more storage towers. The intermediate transport apparatus can transfer the one or more physical objects between the two or more towers via the one or more receptacle.

### RELATED APPLICATIONS

This application claims priority to and the benefit of U.S. Provisional Application No. 62/681,970, filed on Jun. 7, 2018, the content of which is incorporated by reference herein in its entirety.

### BACKGROUND

Physical objects can be stored and later retrieved by autonomous storage and retrieval systems for users. Retrieving physical objects can be inefficient and error prone process.

### BRIEF DESCRIPTION OF DRAWINGS

Illustrative embodiments are shown by way of example in the accompanying drawings and should not be considered as a limitation of the present disclosure:

FIG. 1 is a schematic diagram illustrating an exemplary arrangement of storage towers and intermediate transport apparatuses;

FIGS. 2A-B depict an exemplary storage tower in accordance with embodiments;

FIG. 3 depicts an intermediate transport apparatus in accordance with an exemplary embodiment;

FIGS. 4A-4B depict exemplary arrangements of towers and intermediate transport apparatuses in accordance with an exemplary embodiment;

FIG. 5 is a block diagram of a storage receptacle in accordance with an exemplary embodiment.

FIG. 6 depicts an exterior of a storage tower in accordance with an exemplary embodiment;

FIGS. 7A-B are block diagrams illustrating an object storage and retrieval system according to an exemplary embodiment;

FIG. 8 is a block diagram illustrating an exemplary computing device in accordance with an exemplary embodiment;

FIG. 9 is a flowchart illustrating an exemplary process in accordance with an exemplary embodiment; and

FIG. 10 is a flowchart illustrating an exemplary process in accordance with an exemplary embodiment.

### DETAILED DESCRIPTION

Described in detail herein are embodiments of object storage and retrieval systems. Each storage towers in the system can store and dispense physical objects. The storage towers can have an octagonal prism-shaped (octagonal column) housing, one or more shelving units disposed within the housing, and one or more receptacles defining one or more openings in the housing through which objects are inserted into the tower or dispensed from the tower. The shelves can each support and store one or more physical objects. An interactive display can be disposed on the outside surface of one or more of the storage towers, and can receive input associated with requests for the retrieval or storage of physical objects. A loader disposed in the housing of each storage tower, can transfer one or more of the physical objects between the one or more receptacles and shelves of the shelving unit. An intermediate transport apparatus disposed external to the storage towers and positioned between two or more of the storage towers, can be aligned or selectively aligned with one of the one or more receptacles of each of two or more of the storage towers. The intermediate transport apparatus can transfer one or more physical objects from one storage tower to another storage tower via the one or more receptacles on the first and second towers.

A computing system in communication with storage towers and the intermediate transport apparatus can receive a request from a first one the storage towers for retrieval of a physical object stored in a second one the storage towers. The computing system can instruct the second one of the storage towers to transport, via a loader of the second one of the storage towers, the physical object to receptacle of the second one of the storage towers aligned with the intermediate transport apparatus. The intermediate transport apparatus can receive the physical object from the first one of the receptacles and can transport the physical object to a receptacle of the first one of the storage towers. The computing system can instruct the first one of the storage towers to receive the physical object from the intermediate transport apparatus via the receptacle of the first one of the storage towers. The computing system can instruct the first one of the storage towers to transfer the physical object to another receptacle of the first one of the storage towers to dispense the physical object from the other receptacle of the first one of the storage towers.

In accordance with embodiments of the present disclosure, a database in communication with the computer system, can store information associated with the physical objects, the storage towers, and the intermediate transport apparatus. A request for retrieval of a physical object can include an identifier for the physical object and the receptacle at which the at least one physical object is to be output. The computing system can query the database to determine within which of the storage towers the at least one physical object is disposed and can orchestrate retrieval and transport of the physical object between storage towers via the one or more intermediate transport apparatuses to deliver the requested physical object to the receptacle identified in the request.

In accordance with embodiments of the present disclosure, the computing system can determine an estimated time of delivery based on the received request and initiate transmitting instructions to controllers of the first and second octagonal towers at a specified time based on the estimated time of delivery.

In accordance with embodiments of the present disclosure, the intermediate transport apparatus comprises a shaft and a transport apparatus configured to traverse the shaft.

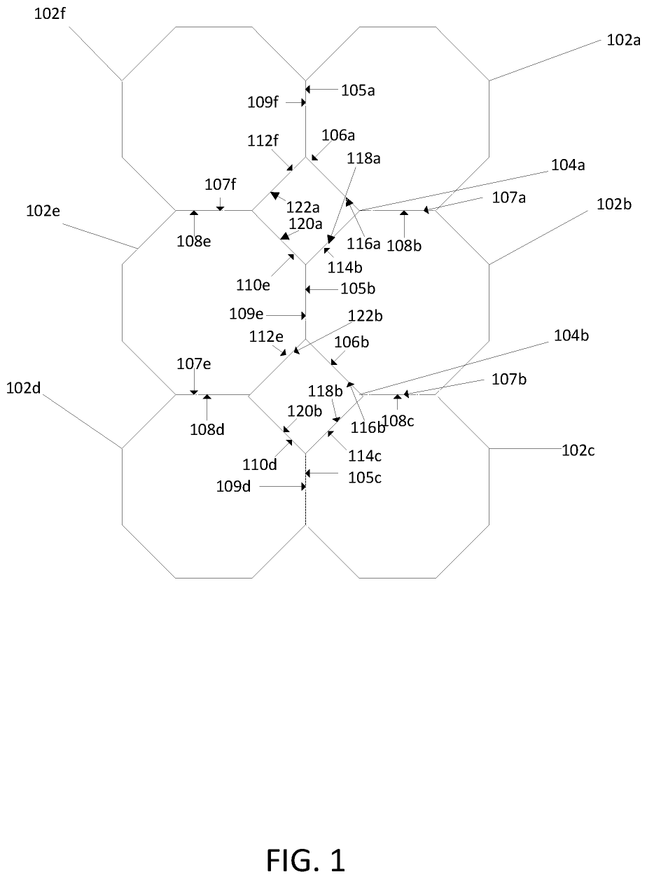

FIG. 1 is a block diagram illustrating a top plan view of an exemplary arrangement of towers and intermediate transport apparatuses. In an exemplary embodiment, storage towers 102a-f and intermediate transport apparatuses 104a-b can be arranged to form a truncated square prismatic honeycomb. As an example, an arrangement 100 can include storage towers 102a-f and intermediate transport apparatuses 104a-b. Each of the storage towers 102a-f can have a generally octagonal perimeter or outline in the top plan view. The intermediate transport apparatuses 104a-b can have a square or rectangular shaped perimeter or outline in the top plan view. Each of the intermediate transport apparatuses 104a-b can be disposed between two or more storage towers 102a-f.

Each storage tower 102a-f can include eight side faces. For example, a side face 108b of storage tower 102b can be disposed adjacent to a side face 107a of storage tower 102a. A side face 109f of storage tower 102f can be disposed adjacent to another side face 105a of storage tower 102a. A side face 108c of storage tower 102c can be disposed adjacent to another side face 107b of storage tower 102b. A side face 109e of storage tower 102e can be disposed adjacent to another side face 105b of storage tower 102b. A side face 109d of storage tower 102d can be disposed adjacent to another side face 105c of storage tower 102c. Another side face 107e of storage tower 102e can be disposed adjacent to another side face 108d of storage tower 102d. Another side face 107f of storage tower 102f can be disposed adjacent to another side face 107e of storage tower 102e.

Side faces 116a, 118a, 120a, and 122a of intermediate transport apparatus 104a can be disposed between side faces 106a, 114b, 110e, and 112f of storage towers 102a, 102b, 102e, and 102f, respectively. Side faces 116b, 118b, 120b, and 122b of intermediate transport apparatuses 104b can be disposed between and along a side faces 106b, 114c, 110d, and 112e of storage towers 102b, 102c, 102d, and 102e, respectively.

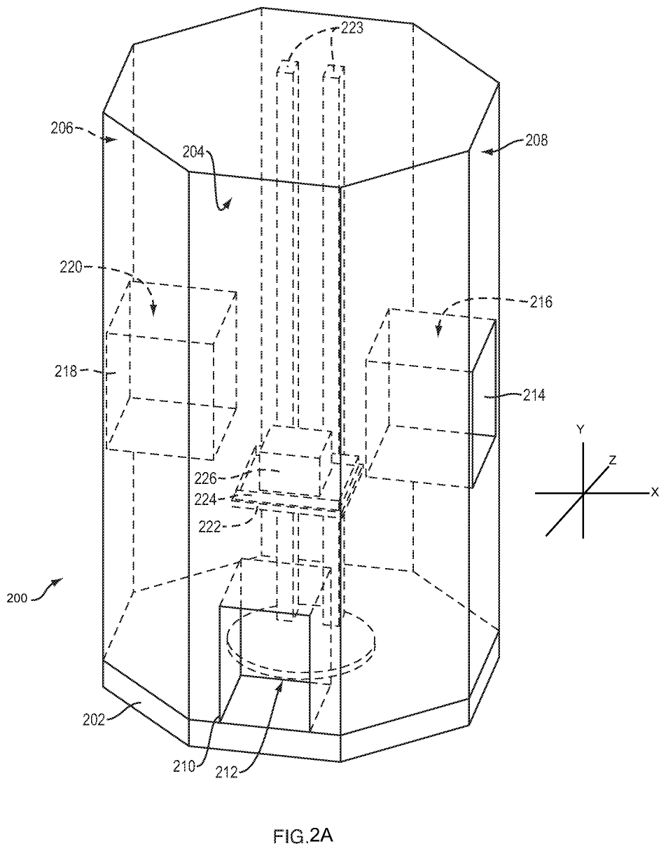

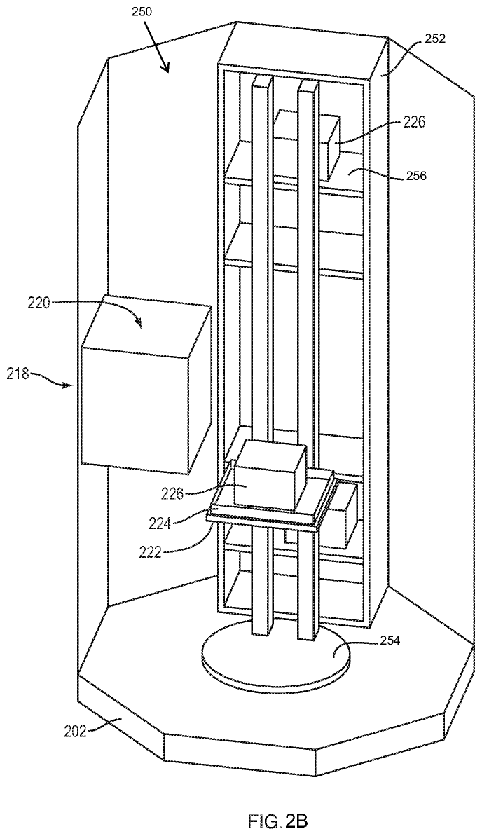

FIGS. 2A-B is a block diagram of an exemplary storage tower 200 in accordance with an exemplary embodiment. With reference to FIG. 2A, the storage tower 200 can form one or more of the storage towers 102a-f shown in FIG. 1 in accordance with embodiments of the present disclosure. The storage tower 200 can include a base 202 coupled to a housing including eight surfaces extending generally vertically from the base 202. The surfaces can include a front face 204, a first side face 206, and a second side face 208. A front opening 210 can be disposed on the front face 204. A first side opening 218 can be disposed on the first side face 206. A second side opening 214 can be disposed on the second side face 208. The openings, e.g., front opening 210, first side opening 218, and second side openings 214, can be retractable doors, windows, or panels.

An interior of the storage tower 200 can include a loader 222 coupled to railings 223. The loader 222 can be configured to transport and support a tray 224, which is configured to support a physical object 226. The loader 222 is further configured to move along the railings 223 along the y-axis. The interior of the storage tower 200 can further include front storage receptacle 212 aligned with and/or coupled to the front opening 210. A first side storage receptacle 220 can be aligned with and/or coupled to the first side opening 218. A second side storage receptacle 216 can be aligned with and/or coupled to the second side opening 214. The front storage receptacle 212, first side storage receptacle 220, and second side storage receptacle 216 can include a storage volume, configured to store objects, such as the tray 224 and the physical object 226. The front opening 210, first side opening 218, and second side opening 214 can provide access to the storage volume of the front storage receptacle 212, first side storage receptacle 220, and second side storage receptacle 218, respectively.

In an exemplary operation, the storage tower 200 can receive a request to retrieve a physical object 222 stored within the storage tower 200. The loader 222 can be controlled to traverse up or down the railings 223. The railings 223 can rotate around a center axis to rotate the loader 222 to an orientation for interfacing with a shelving unit storing the physical object 226. The loader 222 can pick-up the tray 224 supporting the physical object 226 and deposit the tray 224 supporting the physical object 226 in the front storage receptacle 212, the first side storage receptacle 216, or the second side storage receptacle 220.

With reference to FIG. 2B, the interior of the storage tower 200 can include eight interior walls 250 defined by the housing. The interior of the storage tower 200 can include a shelving unit 252, a loader 222, railings 223, and a rotating base 254. The railings 223 can be coupled to the rotating base 254. The loader 222 can be configured to support and transport the tray 224. The tray 224 can support the physical object 226. The loader 222 can be coupled to the railings 223. The loader 222 can extend perpendicularly from the railings 223. As an example, the loader 222 can be a pallet. The railings 223 can operate as a boom to lower and raise the loader 222. The rotating base 254 can rotate the railings 223 360 degrees.

The shelving unit 252 can include shelves 256 configured to store and support physical objects 226. The shelving unit 252 can be disposed along one or more of the interior walls 250 of the storage tower 200. For example, the shelving units 252 can be disposed along one interior wall, each interior wall or a subset of the interior walls 250 of the storage tower 200. The front opening 214 of the storage tower 200 can include a front receptacle (front receptacle 212 as shown in FIG. 2A).

As an example, the loader 222 can receive instructions to load a physical object 226 from the shelving unit 252, onto the loader 222, and load the physical object 226 into a first side receptacle 220. The rotating base 254 can be configured to rotate the railings 223 circumferentially around the interior of the storage tower 200 so that the railings 223 are parallel to the appropriate shelving unit 252. The loader 222 can vertically move up and down the railings 223 to align itself with the shelf 256 on which the requested physical object 226 is disposed.

The loader 222 can pick up the tray 224 supporting the physical object 226. The loader 222 can traverse along and rotate about the railings 223, transport and deposit the tray 224 and physical object 220 in the first side receptacle 220. The physical object 226 can be stored in the first side receptacle 220, until ejected from the first side opening 218.

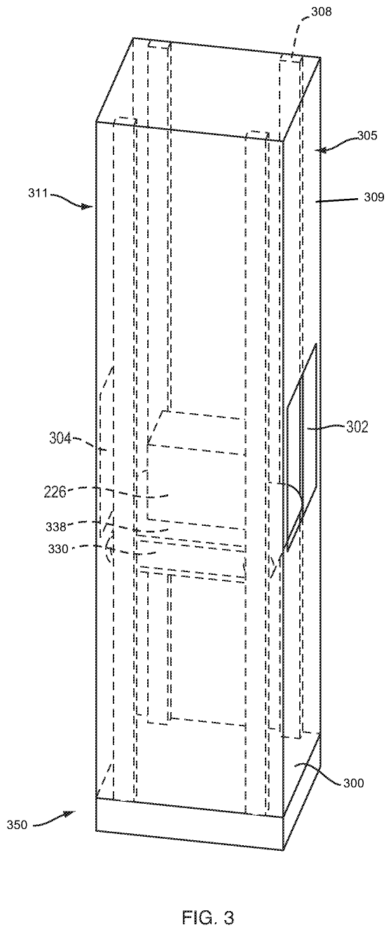

FIG. 3 is a block diagram of the intermediate transport apparatus 350 in accordance with an exemplary embodiment. The intermediate transport apparatus 350 can include a base 300 and a rectangular housing 305, extending vertically from the base 300. The outside of the housing 305 can include four faces, including a first side wall 309 and a second side wall 311. The first side wall 309 can include a first opening 304 and the second side wall can include a second opening 302.

The interior of the housing 305 can include an interior volume 301. The interior volume can include a shaft 306, surrounded by railings 308. A transport apparatus 338 can be coupled to the railings 308. The first or second openings 304 or 302 can be configured to receive physical objects 226. The transport apparatus 338 can be a crane or lift that includes a conveyer belt 330, configured to support and transport a physical object 226 from a first end of the transport apparatus 338 to a second end of the transport apparatus 338. The transport apparatus 338 can move vertically up and down the shaft 306, transporting physical objects to or from the first or second openings 302-304.

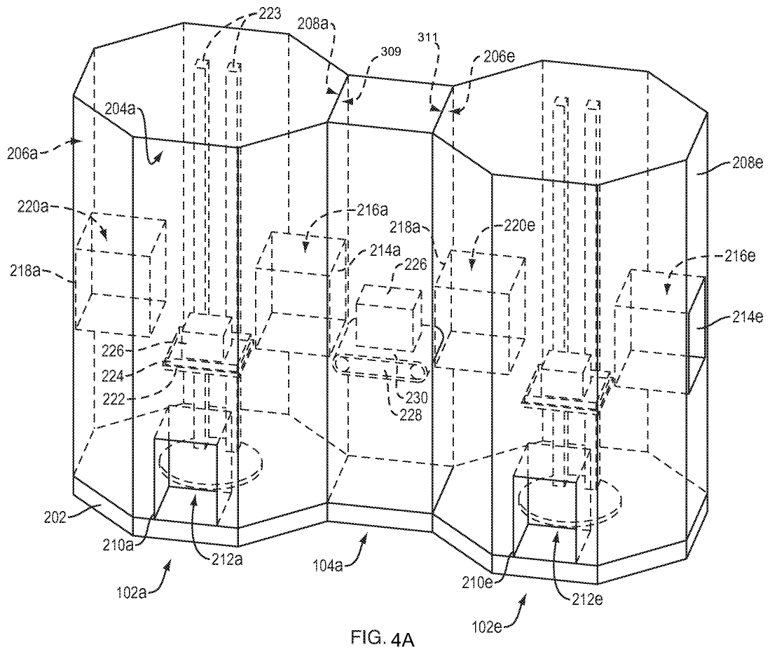

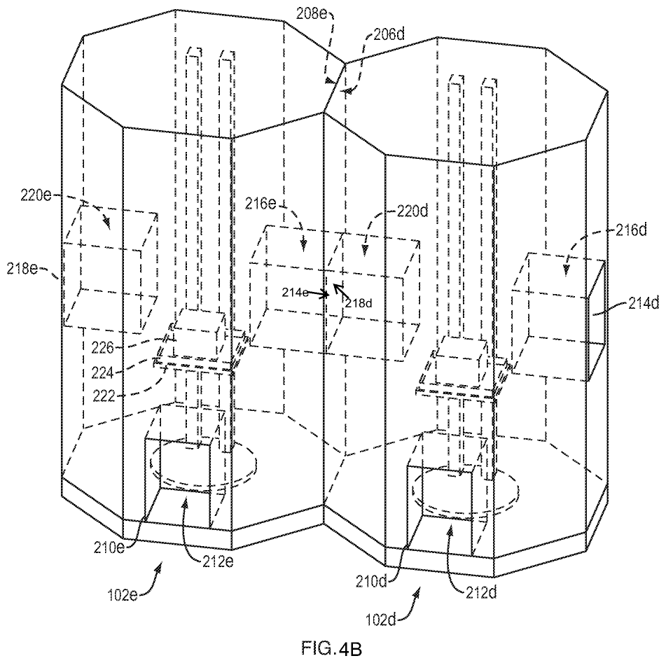

FIG. 4A depicts an exemplary arrangement of storage towers and an intermediate transport apparatus. The intermediate transport apparatus 104a can be disposed between the storage towers 102a and 102e. The first side wall 309 of the intermediate transport apparatus can be aligned and adjacent to the second side face 208a of the storage tower 102a. The second side opening 214a disposed on the second side face 208a of the storage tower 102a can be aligned with and adjacent to the opening disposed on the first side wall 309 of the intermediate transport apparatus 104a. The second side wall 311 of the intermediate transport apparatus 104a can be aligned and adjacent to the first side face 206e of the storage tower 102e. The first side opening 218e disposed on the first side face 206e of the storage tower 102e can be aligned with and adjacent to the opening disposed on the second side wall 311 of the intermediate transport apparatus 104a.

Physical objects 226 can be disposed in the storage towers 102a and 102e. Physical objects 226 can be transferred to and from the storage tower 102a and/or 102e using the intermediate transport apparatus 104a. As an example, storage tower 102a can receive a request for dispensing a physical object 226 disposed in storage tower 102e. The loader 222, of storage tower 102e, can transport the physical object 226 disposed on the tray 224, to the first side storage receptacle 220e. The loader 222, of storage tower 102e can deposit the tray 224 supporting the physical object 226 in the first side storage receptacle 220e, of the storage tower 102e.

The tray 224 supporting the physical object 226 can be transferred from the first side storage receptacle 220e, of the storage tower 102e, to the transport apparatus 338, of the intermediate transport apparatus 104a, through the first side opening 218e of the storage tower 102e, and the opening on the second side wall 311 of the intermediate transport apparatus 104a. The conveyer belt 330 of the transport apparatus 338 can transport one end of the transport apparatus 338, which is proximate to the first side opening 218e of the storage tower 102e, to an opposite end of the transport apparatus 338, which is proximate to the second side opening 214a of the storage tower 102a. The transport apparatus 338 can transfer the physical object 226 through the second side opening 214a into the storage volume of the second side storage receptacle 216a of the storage tower 102a, of the storage tower 102a. In one embodiment, the tray 224 supporting the physical object 226 can be transferred from first side storage receptacle 220e to the transport apparatus 338, and then to second side storage receptacle 216a. In another embodiment, a tray 224 can be disposed in the storage volume of the second side storage receptacle 216a, and the physical object 226 can be transferred from the transport apparatus 338 to the second side storage receptacle 215a to be disposed on the tray 224.

The tray 224 supporting the physical object 226 can be transferred from the second side storage receptacle 216a to the loader 222, of the storage tower 102a. The loader 222 can traverse down the railings 223 and deposit the tray 224 supporting the physical object 226, in the front storage receptacle 212a. The tray 224 supporting the physical object 226 can be ejected from the front storage receptacle 212a through the front opening 210a.

FIG. 4B depicts an exemplary arrangement of storage towers. The storage tower 102d can be disposed adjacent to storage tower 102e. The first side face 206d of the storage tower 102d, can be aligned with and adjacent to the second side face 208e of the storage tower 102e. The second side opening 214e disposed on the second side face 208e of the storage tower 102e can be aligned with and adjacent to the first side opening 218d disposed on the first side face 206d of the storage tower 102d.

As an example, storage tower 102e can receive a request for dispensing a physical object 226 disposed in storage tower 102d. The loader 222, of storage tower 102d, can transport the physical object 226 disposed on the tray 224, to the first side storage receptacle 220d. The loader 222, of storage tower 102d can deposit the tray 224 supporting the physical object 226 in the first side storage receptacle 220d, of the storage tower 102d.

The tray 224 supporting the physical object 226 can be transferred from the first side storage receptacle 220d, of the storage tower 102e, through the first side opening 218d of the storage tower 102d, through the second side opening 214e into the storage volume of the second side storage receptacle 216e of the storage tower 102e. The tray 224 supporting the physical object 226 can be transferred from the second side storage receptacle 216e to the loader 222, of the storage tower 102e. The loader 222 can traverse down the railings 223 and deposit the tray 224 supporting the physical object 226, in the front storage receptacle 212e. The tray 224 supporting the physical object 226 can be ejected from the front storage receptacle 212e through the front opening 210a.

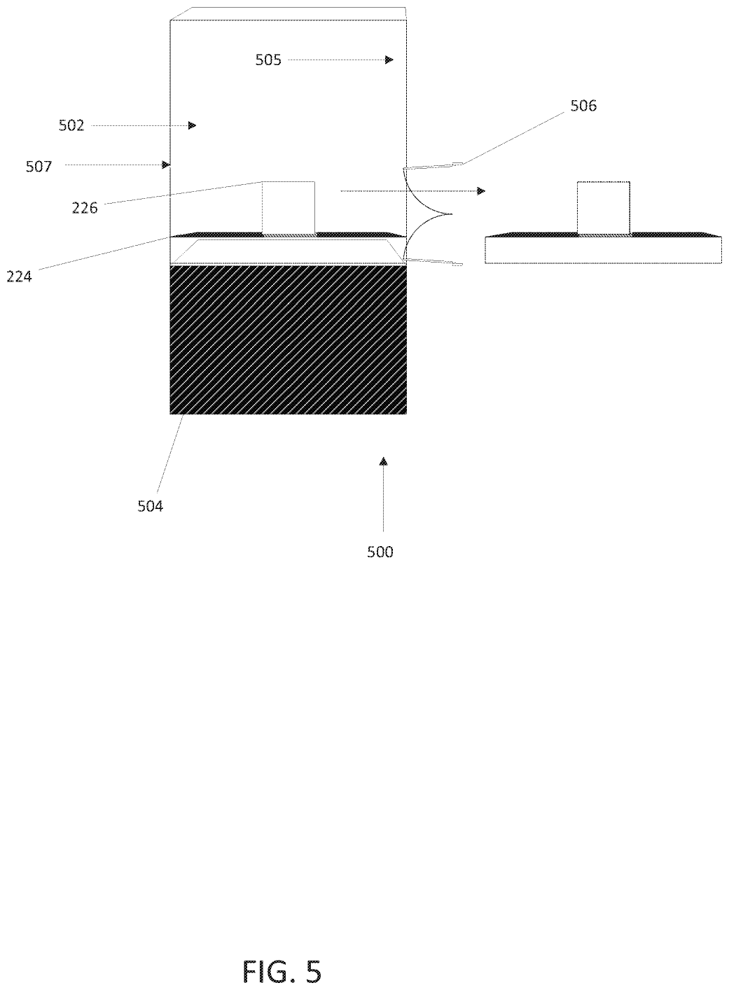

FIG. 5 is a block diagram of a storage receptacle 500 in accordance with exemplary embodiments. As described above, a storage tower can include a front, first side, and second side storage receptacle. The storage receptacle 500 can be embodied as the front, first side and/or second side receptacle. The storage receptacle 500 can include an interior storage volume 502 and a base 504 within the interior storage volume 502. The base 504 can support a tray 224, which can support a physical object 226. The front side 505 of the storage receptacle 500 can include a door 506. The back side 507 of the storage receptacle 500 can be an open face. The storage receptacle 500 can be configured to receive and eject the tray 224 and physical object 226 from the door 506 on the front side and through the open face of the back side 507. The door can be a sliding door (sliding horizontally or vertically), a rotating door, a hinged door, and/or a double door.

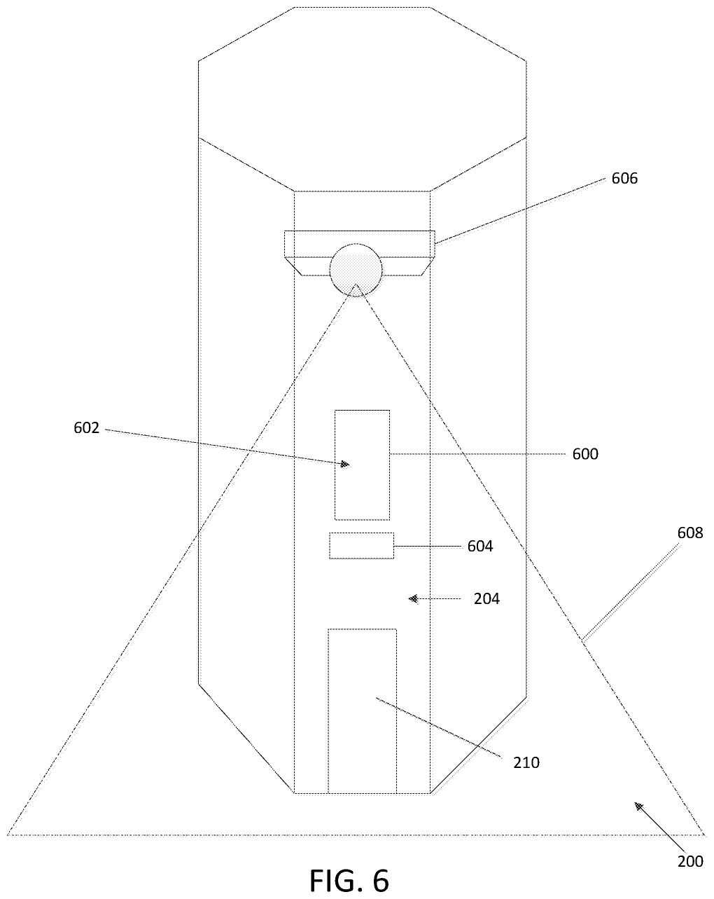

FIG. 6 is a schematic diagram of an exterior of an embodiment of the storage tower 200 in accordance with an exemplary embodiment. An interactive display 600 can be disposed on the storage tower 200. The interactive display 600 can be disposed on the front surface 204 with respect to the front opening. An input device 604 can also be disposed on the storage tower. The input device 604 can be disposed on the front surface 204 with respect to the front opening 210. The input device 604 can be one or more of, an optical scanner, a keyboard/keypad, and image capturing device.

The interactive display 600 can render a graphical user interface (GUI) 602. The GUI 602 can display information associated with a request for dispensing a physical object through the front opening of the storage tower. As an example, a user can input information associated with a request for dispensing a physical object. The information can be an identifier, a name, a username, a pin number or any suitable information that can be used to identify the physical object to be retrieved or stored. As a non-limiting example, the user can enter the information, via a touchscreen display incorporated in the interactive display 602. Alternatively, or in addition to, the interactive display 602 can have multiple input devices such as a keyboard, mouse, joystick, touchpad, or other devices configured to interact with the interactive display 602, such as the input device 604. The user can input identification information using the input device 604

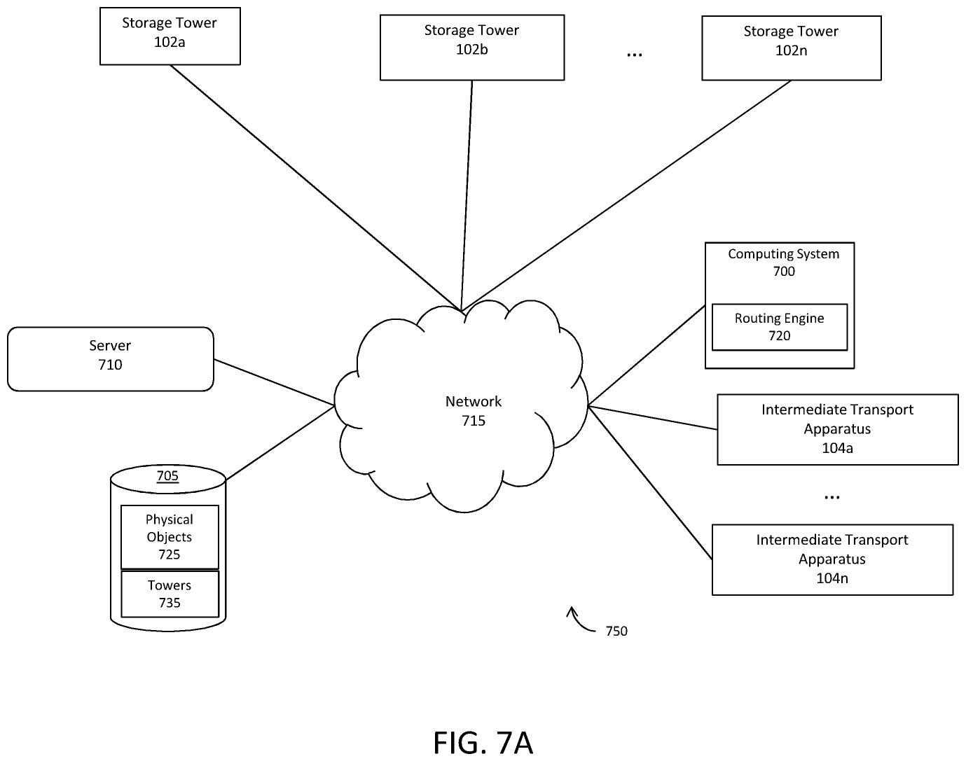

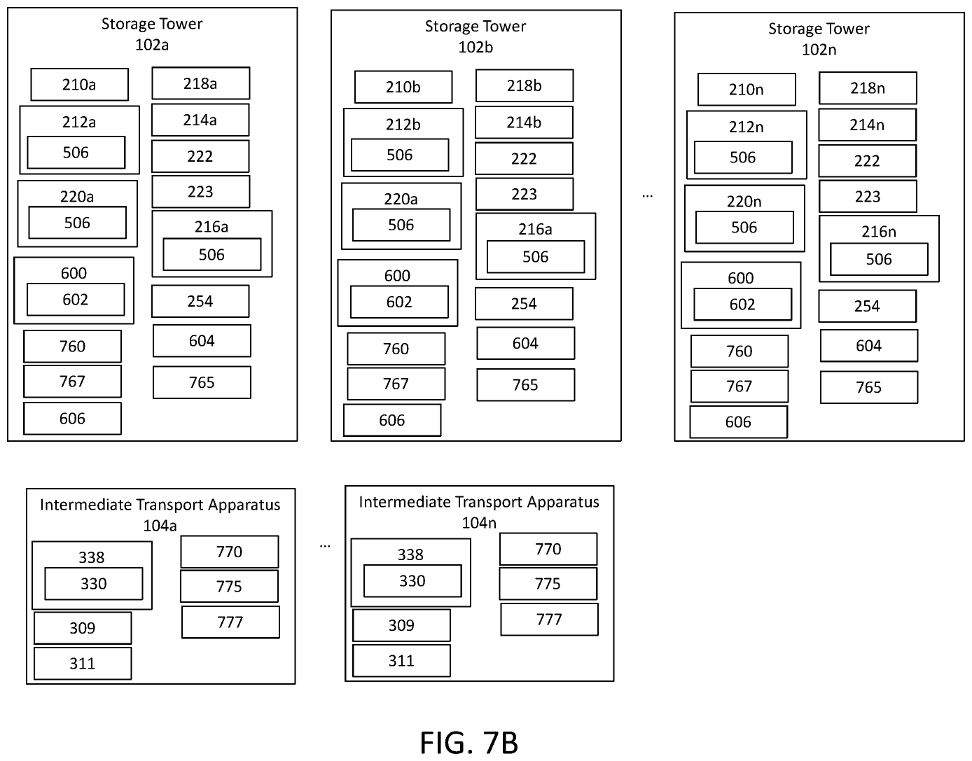

The user can also scan a machine-readable element encoded with an identifier associated with the physical object, using the input device 604. As an example, the input device 604 can be an optical scanner or an image capturing device. The input device 604 can scan/capture and decode the identifier from the machine-readable element. The machine-readable element can be a barcode or a QR code. The input device 604 can transmit the identifier to the interactive display. The interactive display 602 can receive the information associated with the request and transmit the information to a computing system. The computing system will be described in greater detail with respect to FIG. 7A-7B.

In one embodiment, a motion sensor 606 can be disposed on the front surface 204 of the storage tower 200. The motion sensor can detect a user approaching the storage tower 200, within a given radius 608. The doors of the front opening 210 can automatically open in response to the motion sensor 606 detecting a user approaching the storage tower 200. Alternatively, or in addition to, the interactive display 602 can be powered down (in energy saving mode) and in response to the motion sensor detecting a user entering the radius 608, the interactive display 602 can be powered on.

In one embodiment, the user can request to dispense a physical object, disposed in the storage tower 200 or another storage tower. The user can input identification information associated with the using the interactive display 602 and/or input device 604. The identification information can be transmitted to the computing system. The computing system can instruct the storage tower 200 in which the physical object is disposed to dispense the physical object. In the event the physical object is disposed in the storage tower 200, the storage tower 200 can dispense the physical object through the front opening 210 of the storage tower 200.

FIGS. 7A-7B illustrate an exemplary autonomous object storage and retrieval system 750 in accordance with an exemplary embodiment. With reference to FIG. 7A, the autonomous object storage and retrieval system 750 can include one or more databases 705, one or more servers 710, one or more computing systems 700, one or more storage towers 102a-n, and one or more intermediate transport apparatuses 104a-n. The computing system 700 can include a routing engine 720. The routing engine 720 can implement the autonomous object storage and retrieval system 750.

In an example embodiment, one or more portions of the communications network 715 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a Wi-Fi network, a WiMAX network, any other type of network, or a combination of two or more such networks.

The server 710 includes one or more computers or processors configured to communicate with the computing system 700, the databases 705, storage towers 102a-n and intermediate transport apparatuses 104a-n, via a communications network 715. The server 710 hosts one or more applications configured to interact with one or more components computing system 700 and/or facilitates access to the content of the databases 705. The databases 705 may store information/data, as described herein. For example, the databases 705 can include physical objects database 725 and a towers database 735. The physical objects database 725 can store information associated with physical objects. The towers database 735 can store information associated with the storage towers location and physical object disposed in the storage towers. The databases 705 can be located at one or more geographically distributed locations from the computing system 700. Alternatively, the databases 705 can be located at the same geographically as the computing system 700.

With reference to FIG. 7B, the storage towers 102a-n can include a loader 222 coupled to railings 223 which are coupled to a rotating base 254, a front face opening 210a-n, a front storage receptacle 212a-n, a first side opening 218a-n, a first side storage receptacle 220a-n, a second side opening 214a-n, a second side storage receptacle 216a-n, a controller 760, and a transceiver 765. The front, first side and second side storage receptacles 212a-n, 220a-n, and 216a-n, can include a door 506. The storage towers 102a-n can also include an interactive display 600 including a GUI 602, an input device 604, and a sensor 606. The storage towers 102a-n can also be coupled to a power source 767. The power source 767 can provide power to a controller 760, transceiver 765, loader 222, rotating base 254, the doors 506, the interactive display 600, input device 604, and the sensor 606. The transceiver 765 can be configured to receive and transmit data, via the network 715. The controller 760 can control the operations of the loader 222, rotating base 254, the doors 506, the interactive display 600, input device 604, and the sensor 606, based on received data from the transceiver 765.

The intermediate transport apparatuses 104a-n can include a transport apparatus 338, a first opening 304, second opening 302, a controller 770, and a transceiver 775. The transport apparatus 338 can include a conveyer belt 330. The intermediate transport apparatuses 104a-n can be coupled to a power source 777. The power source 777 can provide power to the transport apparatus 338, the controller 770, and the transceiver 775. The transceiver 775 can be configured to receive and transmit data. The controller 770 can control the operations of the transport apparatus 338 and the conveyer belt 330, based on received data from the transceiver 775.

With concurrent reference to FIG. 7A-7B, in an exemplary embodiment, storage towers 102a-f and one and more intermediate transport apparatus 104a-f can be disposed in a facility. The storage towers 102a-f can be disposed adjacent to one another (e.g., as shown in FIG. 1). The one more intermediate transport apparatuses 104a-n can be disposed between at least two storage towers 102a-f. Physical objects can be disposed in the storage towers 102a-n.

A user can request a physical object to be dispensed at one of the storage towers 102a-n. The user can input identification information associated with the physical object at the interactive display 702 and/or input device 604. The controller 760 of storage tower 102a can receive the identification information and transmit the identification information associated with the physical object to the computing system 700.

The computing system 700 can receive the identification information associated with the physical object and execute the routing application 720. The routing application 720 can query the physical objects database 725 to retrieve information associated with the physical object including the storage tower in which the physical object is disposed and the ownership information of the physical object. The routing application 720 can query the towers database 735 to retrieve information associated with the storage tower in which the physical object is disposed.

As an example, the requested physical object can be disposed in one of the storage towers 102n, while as described above, the request can originate from a different one of the storage towers 102a. The routing engine 720 can determine a route for the physical object to travel from the storage tower 102n in which the physical object is disposed to the storage tower 102a from which the request originated. The routing engine 720 can determine the physical object can be transferred to one or more intermediate transport apparatuses 104a-n, such as intermediate transport apparatus 104a, then to one or more storage towers 102a-n, such as storage tower 102b, and then to the storage tower 102a from which the request originated. The routing engine 720 can instruct the storage tower 102n in which the physical object is disposed, the intermediate apparatus 104a, the storage tower 102b, to transfer the physical object to the storage tower 102a from which the request originated.

In response to the transceiver of storage tower 102n receiving the instructions from the routing engine 720, the controller 760 of storage tower 102n can control the rotating base 254 and the loader 222 of storage tower 102n to retrieve the physical object from the shelving unit in the storage tower 102n. The loader 222 can pick-up the tray supporting the physical object from the shelving unit and deposit the tray and the physical object in a first or second side receptacle 220n, 216n of the storage tower 102n. The first or second side openings 218n, 214n of the storage tower 102n can be aligned with the first or second side openings 304, 302 of the intermediate transport apparatus 104a. The controller 760 of storage tower 102n can control the door 506 of the first or second side receptacle 220n, 216n, to open. In response to opening the door, the tray supporting the physical object can be ejected from the first or second side receptacles 220n, 216n through the first or second side openings 218n, 214n into the intermediate transport apparatus 104a, through the first or second side openings 304, 302 of the intermediate transport apparatus 104a.

In one embodiment, the transport apparatus 338 of the intermediate transport apparatus 104a can receive the tray supporting the physical object as soon as the tray supporting the physical object is received through the first or second side openings 304, 302 of the intermediate transport apparatus 104a. The controller 770 can control the conveyer belt 330 of the transport apparatus 338 to transport the tray supporting the physical object through the first or second opening 304, 302 of the intermediate transport apparatus 104, which is aligned with the first or second side opening 218b, 214b of the storage tower 102b. The controller 760 of storage tower 102b can control the door 506 of the first or second side receptacle 220b, 216b. In response to opening the door 506, the transport apparatus 338 can transport the tray supporting the physical object into the storage volume of the first or second side storage receptacle 220b, 216b, through the first or second side openings 218b, 214b of the storage tower 102b.

The controller 760 of storage tower 102b can instruct the loader 222 to pick-up the tray supporting the physical object from the first or second side storage receptacle 220b, 216b of the storage tower 102b and transport the tray supporting physical object to the first or second receptacle 220b, 216b of storage tower 102b which is aligned to the first or second side openings 218a, 214a of storage tower 102a. The controller 760 of storage tower 102b can control the door 506 of the first or second side receptacle 220b, 216b, to open. Additionally, the controller 760 of storage tower 102a can control the door 506 of the first or second side receptacle 220a, 216a, to open. In response to opening the doors 506, the tray supporting the physical object can be ejected from the first or second receptacle 220b, 216b of storage tower 102b through the first or second openings 218b, 214b of the storage tower 102b and into the storage volume first or second receptacle 220a, 216a of storage tower 102a.

The controller 760 of storage tower 102a can instruct the loader 222 of storage tower 102a to pick-up the tray supporting the physical object from the first or second side storage receptacle 220a, 216a and deposit the physical objet in the front storage receptacle 212a of the storage tower 102a. The controller 760 of storage tower 102a can control the door 506 of the front storage receptacle 212a, to open. In response to opening the door, the tray supporting the physical object can be ejected through the front opening 210a the storage tower 102a. It can be appreciated, a request for a physical object can be made at any of the storage towers 102a-n and physical object can be disposed in any of the storage towers 102a-n.

In one embodiment, the routing engine 720 can determine an estimated time of arrival of the user to a specified storage tower 102a-n. The routing engine 720 can instruct the storage towers and intermediate transport apparatus to transfer the physical object to the appropriate storage tower by the ETA of the user.

In another embodiment, the storage towers 102a-n can receive physical objects for storage. The routing engine 720 can determine the storage tower 102a-n receiving the physical object does not have enough storage to store the physical object. The routing engine 720 can instruct the storage towers 102a-n and the intermediate transport apparatuses 104a-n to transfer the physical object to a storage tower with enough storage space for the physical object.

As a non-limiting example, the autonomous storage and retrieval system 750 can be implemented in a retail store. The storage towers 102a-n and intermediate transport apparatus 104 can be disposed at the retail store. The physical object can be products purchased or about to be purchased by users from the retail store. The user can be a customer of the retail store and can pick-up products from the storage towers. As an example, the user can purchase something online and pick-up the product from the storage tower 102a-n. Alternatively, or in addition to, the user can use the interactive display 702 of the storage towers 102a-n and/or a Point-of-Sale (POS) terminal of the retail store to purchase a product and pick-up the product from the storage towers 102a-n. As described above, the user can request the physical object from any of the storage towers 102a-n.

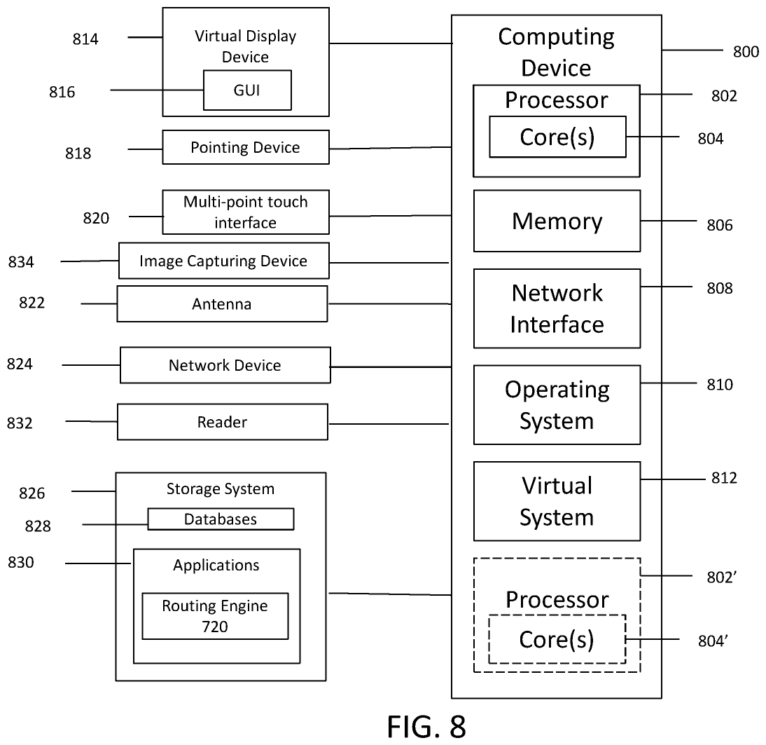

FIG. 8 is a block diagram of an example computing device for implementing exemplary embodiments of the present disclosure. The computing device 800 may be, but is not limited to, a smartphone, laptop, tablet, desktop computer, server or network appliance. The computing device 800 can be embodied as part of the computing system or storage tower. The computing device 800 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 806 included in the computing device 800 may store computer-readable and computer-executable instructions or software (e.g., applications 830 such as the routing engine 720) for implementing exemplary operations of the computing device 800. The computing device 800 also includes configurable and/or programmable processor 802 and associated core(s) 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for implementing exemplary embodiments of the present disclosure. Processor 802 and processor(s) 802′ may each be a single core processor or multiple core (804 and 804′) processor. Either or both of processor 802 and processor(s) 802′ may be configured to execute one or more of the instructions described in connection with computing device 800.

Virtualization may be employed in the computing device 800 so that infrastructure and resources in the computing device 800 may be shared dynamically. A virtual machine 812 may be provided to handle a process running on multiple processors so that the process appears to be using only one computing resource rather than multiple computing resources. Multiple virtual machines may also be used with one processor.

Memory 806 may include a computer system memory or random access memory, such as DRAM, SRAM, EDO RAM, and the like. Memory 806 may include other types of memory as well, or combinations thereof.

A user may interact with the computing device 800 through a visual display device 814, such as a computer monitor, which may display one or more graphical user interfaces 816, multi touch interface 820, a pointing device 818, an image capturing device 834 and a scanner 832.

The computing device 800 may also include one or more computer storage devices 826, such as a hard-drive, CD-ROM, or other computer-readable media, for storing data and computer-readable instructions and/or software that implement exemplary embodiments of the present disclosure (e.g., applications). For example, exemplary storage device 826 can include one or more databases 828 for storing information regarding physical objects and the storage towers. The databases 828 may be updated manually or automatically at any suitable time to add, delete, and/or update one or more data items in the databases.

The computing device 800 can include a network interface 808 configured to interface via one or more network devices 824 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 822 to facilitate wireless communication (e.g., via the network interface) between the computing device 800 and a network and/or between the computing device 800 and other computing devices. The network interface 808 may include a built-in network adapter, network interface card, PCMCIA network card, card bus network adapter, wireless network adapter, USB network adapter, modem or any other device suitable for interfacing the computing device 800 to any type of network capable of communication and performing the operations described herein.

The computing device 800 may run any operating system 810, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 800 and performing the operations described herein. In exemplary embodiments, the operating system 810 may be run in native mode or emulated mode. In an exemplary embodiment, the operating system 810 may be run on one or more cloud machine instances.

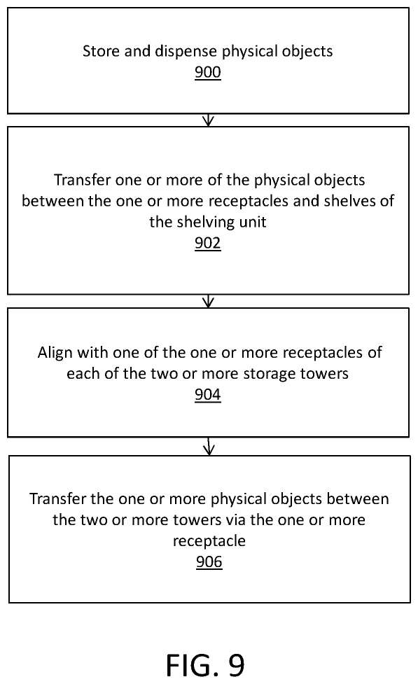

FIG. 9 is a flowchart illustrating the process of the autonomous object storage and retrieval system according to an exemplary embodiment. In operation 900, each of multiple storage towers can store and dispense physical objects. The storage towers can be an octagonal prism-shaped housing, a shelving unit disposed within the housing, and one or more receptacles defining one or more openings in the housing. In operation 902, a loader disposed in the housing of each storage tower, can transfer one or more of the physical objects between the one or more receptacles and shelves of the shelving unit. In operation 904, an intermediate transport apparatus disposed external to the storage towers and positioned between two or more of the storage towers, can align with one of the one or more receptacles of each of the two or more storage towers. In operation 906, the intermediate transport apparatus can transfer the one or more physical objects between the two or more towers via the one or more receptacle.

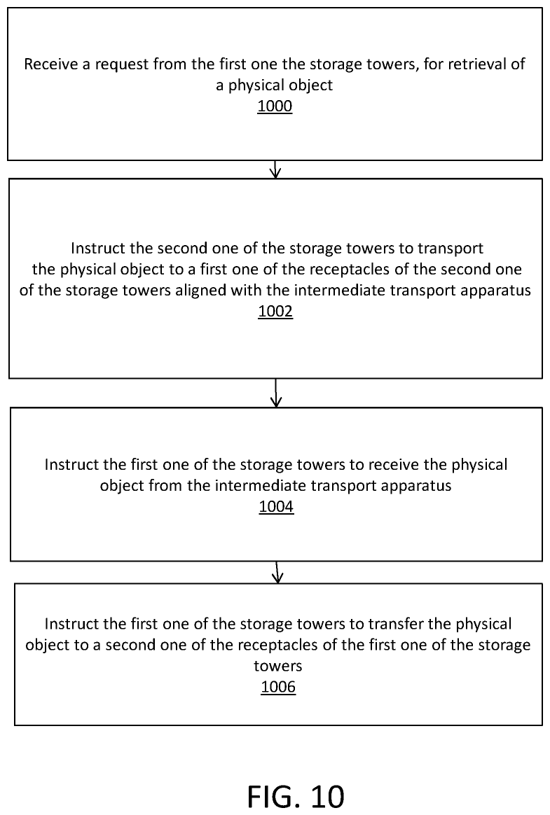

FIG. 10 is a flowchart illustrating the process of the autonomous object storage and retrieval system according to an exemplary embodiment. In operation 1000, a computing system in communication with storage towers and an intermediate transport apparatus disposed between a first and second storage towers, can receive a request from the first one the storage towers, for retrieval of a physical object stored in the second one the storage towers. In operation 1002, the computing system can instruct the second one of the storage towers to transport, via a loader of the second one of the storage towers, the physical object to a first one of the receptacles of the second one of the storage towers aligned with the intermediate transport apparatus. In operation 1004, the computing system can instruct the first one of the storage towers to receive the physical object from the intermediate transport apparatus. In operation 1006, the computing system can instruct the first one of the storage towers to transfer the physical object to a second one of the receptacles of the first one of the storage towers.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

One or more of the exemplary embodiments, include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI is a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An object storage and retrieval system, the system comprising:
a plurality of storage towers configured to store and dispense a plurality of physical objects, each of the plurality of storage towers having an octagonal prism-shaped housing and including:
a shelving unit disposed within the housing,
one or more receptacles defining one or more openings in the housing,
a loader disposed within the housing, the loader being configured to transfer one or more of the physical objects between the receptacle and shelves of the shelving unit,
an intermediate transport apparatus disposed external to the plurality of storage towers and positioned between two or more of the plurality of storage towers, the intermediate transport apparatus being configured to align with at least one of the one or more receptacles of each of the two or more of the plurality of storage towers,
wherein the intermediate transport apparatus transfers the one or more of the physical objects between the two or more towers via the at least one of the one or more receptacle.

2. The system of claim 1, further comprising:
a computing system in communication with the plurality of storage towers and the intermediate transport apparatus, the computing system configured to:
receive a request from a first one of the two or more of the plurality of storage towers for retrieval of at least one physical object of the plurality of physical objects stored in a second one of the two or more of the plurality of storage towers;
instruct the second one of the two or more of the plurality of storage towers to transport, via the loader of the second one of the two or more of the plurality of storage towers to transfer the at least one physical objects to a first one of the one or more receptacles of the second one of the two or more of the plurality of storage towers aligned with the intermediate transport apparatus;
instruct the intermediate transport apparatus to transport the at least one physical object from the first one of the one or more receptacles of the second one of the two or more of the plurality of storage towers to a first one of the one or more receptacles of the first one of the two or more of the plurality of storage towers;
instruct the first one of the two or more of the plurality of storage towers receive the at least one physical object from the intermediate transport apparatus and to transfer the at least one physical object to a second one of the one or more receptacles of the first one of the two or more of the plurality of storage towers.

3. The system of claim 2, further comprising a database in communication with the computing system and configured to store information associated with the physical objects, the plurality of storage towers, and the intermediate transport apparatus.

4. The system of claim 3, wherein the request includes an identifier of the at least one physical object and the second one of the receptacles of the first one of the two or more of the plurality of storage towers at which the at least one physical object is to be output.

5. The system of claim 4, wherein the computing system is configured to query the database to determine within which of the plurality of storage towers the at least one physical object is disposed.

6. The system of claim 2, wherein the computer system is configured to determine an estimated time of delivery based on the received request and initiate transmitting instructions to the controllers of the first and second octagonal towers at a specified time based on the estimated time of delivery.

7. The system of claim 1, wherein shelving unit includes a plurality of shelves configured to support and store one or more physical objects of the plurality of physical objects.

8. The system of claim 1, further comprising an interactive display disposed on an outside surface of each of the octagonal storage towers, configured to receive input associated with the request.

9. The system of claim 1, wherein the intermediate transport apparatus comprises:
a shaft; and
a transport apparatus configured to traverse the shaft.

10. The system of claim 1, wherein the plurality of towers and the intermediate transport apparatus are arranged to form at least one of a truncated square prismatic honeycomb.

11. An object storage and retrieval method, the method comprising:
storing and dispensing, via each storage tower of a plurality of storage towers having an octagonal prism-shaped housing, a shelving unit disposed within the housing, and one or more receptacles defining one or more openings in the housing, a plurality of physical objects;
transferring, via a loader disposed in the housing of each storage tower of a plurality of storage towers, one or more of the physical objects between the one or more receptacles and shelves of the shelving unit;
aligning, via an intermediate transport apparatus disposed external to the plurality of storage towers and positioned between two or more of the plurality of storage towers, with at least one of the one or more receptacles of each of the two or more of the plurality of storage towers; and
transferring, via the intermediate transport apparatus, the one or more of the physical objects between the two or more towers via the at least one of the one or more receptacle.

12. The method of claim 11, further comprising:
receiving, via a computing system in communication with the plurality of storage towers and the intermediate transport apparatus, a request from a first one of the two or more of the plurality of storage towers for retrieval of at least one physical object of the plurality of physical objects stored in a second one of the two or more of the plurality of storage towers;
instructing, via the computing system, the second one of the two or more of the plurality of storage towers to transport, via the loader of the second one of the two or more of the plurality of storage towers to transfer the at least one physical objects to a first one of the one or more receptacles of the second one of the two or more of the plurality of storage towers aligned with the intermediate transport apparatus;
instructing, via the computing system, the intermediate transport apparatus to transport the at least one physical object from the first one of the one or more receptacles of the second one of the two or more of the plurality of storage towers to a first one of the one or more receptacles of the first one of the two or more of the plurality of storage towers;
instructing, via the computing system, the first one of the two or more of the plurality of storage towers receive the at least one physical object from the intermediate transport apparatus and to transfer the at least one physical object to a second one of the one or more receptacles of the first one of the two or more of the plurality of storage towers.

13. The method of claim 11, further comprising storing, via a database in communication with the computing system, information associated with the plurality of physical objects, the plurality of storage towers, and the intermediate transport apparatus.

14. The method of claim 13, wherein the request includes an identifier of the at least one physical object and the second one of the receptacles of the first one of the two or more of the plurality of storage towers at which the at least one physical object is to be output.

15. The method of claim 14, further comprising querying, via the computing system, the database to determine within which of the plurality of storage towers the at least one physical object is disposed.

16. The method of claim 12, further comprising determining, via the computing system, an estimated time of delivery based on the received request and initiate transmitting instructions to the controllers of the first and second octagonal towers at a specified time based on the estimated time of delivery.

17. The method of claim 11, further comprising supporting and storing, via a plurality of shelves of the shelving unit, one or more physical objects of the plurality of physical objects.

18. The method of claim 17, further comprising receiving, via an interactive display disposed on an outside surface of each of the octagonal storage towers, input associated with the request.

19. The method of claim 11, wherein the intermediate transport apparatus comprises:
a shaft; and
a transport apparatus configured to traverse the shaft.

20. The method of claim 11, wherein the plurality of towers and the intermediate transport apparatus are arranged to form at least one of a truncated square prismatic honeycomb.
